(19) United States
(12) Patent Application Publication
(10) Pub. No.: US 2026/0042065 A1
(43) Pub. Date: Feb. 12, 2026

(54) ELECTRODIALYSIS PROCESS WITH ACTIVE FOULANT REMOVAL SEQUENCE

(71) Applicant: Evoqua Water Technologies LLC, Pittsburgh, PA (US)

(72) Inventors: Scott Waugh, Pepperell, MA (US); Li-Shiang Liang, Harvard, MA (US); Frederick C. Wilkins, Pepperell, MA (US); Charles P. Buzzell, Deerfield, NH (US)

(21) Appl. No.: 19/365,370

(22) Filed: Oct. 22, 2025

Related U.S. Application Data
(63) Continuation of application No. 17/263,006.
(60) Provisional application No. 62/703,135, filed on Jul. 25, 2018.

(51) Int. Cl. B01D 61/52; B01D 61/46; B01D 61/54; B01D 65/02; C02F 1/00; C02F 1/469

(52) U.S. Cl. CPC B01D 61/52; B01D 61/463; B01D 61/54; B01D 65/02; C02F 1/008; C02F 1/4693; B01D 2321/02; B01D 2321/167; B01D 2321/223; C02F 2209/05; C02F 2303/16

(57) ABSTRACT

Methods of operating an electrochemical separation device is disclosed. The methods include operating the electrochemical separation device in an active mode until the resistance reaches a predetermined threshold, regenerating the electrochemical separation device in a passive mode until the resistance reaches a predetermined threshold, and resuming operation of the electrochemical separation device in the active mode. The methods also include operating the electrochemical separation device in an active mode for a predetermined period of time, regenerating the electrochemical separation device in a passive mode for a predetermined period of time, and resuming operation of the electrochemical separation device in the active mode. Water treatment systems include the electrochemical separation device and a control module are also disclosed. Methods of facilitating operation of the electrochemical separation device by providing a control sequence are also disclosed.

### CROSS-REFERENCE TO RELATED APPLICATIONS

This application is a continuation of U.S. patent application Ser. No. 17/263,006 filed Jan. 25, 2021, which is a national phase application of International Patent Application No. PCT/US2019/043351 filed Jul. 25, 2019, which claims priority to U.S. Provisional Application Ser. No. 62/703,135 titled “Electrodialysis Process with Active Foulant Removal Sequence” filed Jul. 25, 2018, each of which are incorporated herein by reference in their entirety for all purposes.

### FIELD OF TECHNOLOGY

Aspects and embodiments disclosed herein are generally related to electrochemical separation devices, and more specifically, to systems and methods for regenerating the electrochemical separation devices.

### SUMMARY

In accordance with one aspect, a method of operating an electrochemical separation device is provided. The electrochemical separation device may comprise a dilution compartment, a concentration compartment, an ion exchange membrane positioned between the dilution compartment and the concentration compartment, and first and second electrodes. The method may comprise operating the electrochemical separation device in an active mode until a resistance in the electrochemical separation device reaches a first predetermined threshold. The active mode may comprise transmitting a current between the first and second electrodes, directing a first feed stream to the dilution compartment to produce a product stream, and directing a second feed stream to the concentration compartment to produce a reject stream. The method may comprise regenerating the electrochemical separation device in a passive mode until the resistance reaches a second predetermined threshold lower than the first predetermined threshold. The passive mode may comprise comprising suspending operation of the electrochemical separation device in the active mode. The method may comprise resuming operation of the electrochemical separation device in the active mode until the resistance reaches a third predetermined threshold greater than the second predetermined threshold.

In some embodiments, the method may further comprise determining the resistance in the electrochemical separation device.

The first predetermined threshold may be at least 10 ohm greater than a starting resistance.

The second predetermined threshold may be at least about 10 ohm less than the first predetermined threshold.

The resistance may be an average resistance. The method may further comprise determining the average resistance in the electrochemical separation device.

The first predetermined threshold may be at least about 10 ohm/day greater than a starting resistance.

The second predetermined threshold may be at least about 10 ohm/day less than the first predetermined threshold.

The third predetermined threshold may be unequal to the first predetermined threshold.

The third predetermined threshold may be greater than the first predetermined threshold.

In some embodiments, the method may further comprise reversing polarity of the first and second electrodes.

In some embodiments, the method may further comprise performing a chemical clean on the electrochemical separation device.

In accordance with another aspect, there is provided a method of operating an electrochemical separation device. The electrochemical separation device may comprise a dilution compartment, a concentration compartment, an ion exchange membrane positioned between the dilution compartment and the concentration compartment, and first and second electrodes. The method may comprise operating the electrochemical separation device in an active mode for a first period of time. The active mode may comprise transmitting a current between the first and second electrodes, directing a first feed stream to the dilution compartment to produce a product stream, and directing a second feed stream to the concentration compartment to produce a reject stream. The method may comprise regenerating the electrochemical separation device in a passive mode for a second period of time. The passive mode may comprise suspending operation of the electrochemical separation device in the active mode. The method may comprise resuming operation of the electrochemical separation device in the active mode for a third period of time.

In some embodiments, the first period of time may be sufficient to increase resistance in the electrochemical separation device to a threshold resistance.

The threshold resistance may be at least about 10 ohm greater than a baseline resistance.

The first period of time may be between about 12 hours and about 48 hours.

In some embodiments, the second period of time may be sufficient to decrease resistance in the electrochemical separation device to a baseline resistance.

The baseline resistance may be defined by a gradual linear increase over time from a starting resistance. The gradual linear increase in the resistance may be less than about 10 ohm/day.

The second period of time may be between about 6 hours and about 24 hours.

In some embodiments, the method may further comprise reversing polarity of the first and second electrodes.

In some embodiments, the method may further comprise performing a chemical clean on the electrochemical separation device.

In accordance with another aspect, there is provided a water treatment system. The water treatment system may comprise an electrochemical separation device comprising a dilution compartment having an inlet and a product outlet, a concentration compartment having an inlet and a reject outlet, an ion exchange membrane positioned between the dilution compartment and the concentration compartment, and first and a second electrodes positioned at distal ends of the electrochemical separation device. The water treatment system may comprise a first feed line fluidly connected to the dilution compartment inlet. The water treatment system may comprise a second feed line fluidly connected to the concentration compartment inlet. The water treatment system may comprise a first sensor configured to measure conductivity in the electrochemical separation device. The water treatment system may comprise a control module operatively connected to the first sensor and the first and second electrodes. The control module may be configured to suspend transmission of current between the first and second electrodes and close the dilution compartment inlet and the concentration compartment inlet responsive to a conductivity measurement obtained by the first sensor reaching a threshold value. The control module may be configured to resume transmission of the current and open the dilution compartment inlet and the concentration compartment inlet after a predetermined period of time.

In some embodiments, the system may comprise two or more electrochemical separation devices. Each electrochemical separation device may be individually connected to the first feed line and the second feed line.

The control module may be configured to suspend transmission of the current and close the dilution compartment inlet and the concentration compartment inlet of the two or more electrochemical separation devices nonsimultaneously.

The system may further comprise a second sensor configured to measure flow rate of at least one of fluid in the first feed line and fluid in the second feed line, the second sensor operatively connected to the control module.

The system may further comprise a third sensor configured to measure composition of at least one of fluid in the first feed line and fluid in the second feed line, the third sensor operatively connected to the control module.

The system may further comprise a fourth sensor configured to measure pressure drop in at least one of the concentration compartment and the dilution compartment, the fourth sensor operatively connected to the control module.

In accordance with yet another aspect, there is provided a method of facilitating operation of an electrochemical separation device. The electrochemical separation device may comprise a dilution compartment having an inlet fluidly connectable to a first feed line and a product outlet, a concentration compartment having an inlet fluidly connectable to a second feed line and a reject outlet, an ion exchange membrane positioned between the dilution compartment and the concentration compartment, first and a second electrodes positioned at distal ends of the electrochemical separation device, a sensor configured to measure conductivity in the electrochemical separation device, and a control module operatively connected to the first sensor and to the first and second electrodes. The method may comprise providing a control sequence configured to instruct the control module to operate the electrochemical separation device in an active mode responsive to a conductivity measurement obtained by the first sensor reaching a threshold value or after a first predetermined period of time, and regenerate the electrochemical separation device in a passive mode after a second predetermined period of time.

The method may comprise providing the sensor.

The method may comprise providing the control module.

The method may comprise instructing a user to select at least one of the threshold resistance, the first predetermined period of time, and the second predetermined period of time.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic drawing of an electrochemical separation device, according to one embodiment;

FIG. 2 is a schematic drawing of a water treatment system, according to one embodiment;

FIG. 3 is a schematic drawing of a water treatment system, according to one embodiment;

FIG. 4 is a schematic drawing of a water treatment system, according to one embodiment;

FIG. 5 is a graph of hypothetical module resistance over time of an electrochemical separation, operating according to one embodiment;

FIG. 6 is a graph of average resistance over time of an electrochemical separation device, operating according to open embodiment;

FIG. 7 is a graph of product flow rate over time of an electrochemical separation device, operating according to one embodiment;

FIG. 8 is a graph of conductivity over time of the feed stream and product stream of an electrochemical separation device, operating according to one embodiment; and

FIG. 9 is a graph of overall recovery and instantaneous recovery over time of an electrochemical separation device, operating according to one embodiment.

### DETAILED DESCRIPTION

In accordance with an aspect, there is provided a method of operating an electrochemical separation device. Electrochemical separation devices disclosed herein may comprise a dilution compartment, a concentration compartment, an ion exchange membrane, and first and second electrodes. The ion exchange membrane may be positioned between the dilution compartment and the concentration compartment. Systems and methods disclosed herein may further include a first feed stream or first feed line fluidly connected to the dilution compartment and a second feed stream or second feed line fluidly connected to the concentration compartment.

As used herein, “electrochemical separation device” refers to a device for purifying fluids using an electrical field. Electrochemical separation devices may be commonly used to treat water and other liquids containing dissolved ionic species. Electrochemical separation devices include, but are not limited to, electrodeionization and electrodialysis devices. In some embodiments, the electrochemical device has a plate-and-frame or spiral wound design. Such designs may be used for various types of electrochemical deionization devices including but not limited to electrodialysis and electrodeionization devices. Commercially available electrodialysis devices are typically of plate-and-frame design, while electrodeionization devices may be available in both plate and frame and spiral configurations.

Generally, electrochemical separation devices may employ an electric potential to influence ion transport and remove or reduce a concentration of one or more ionized or ionizable species from a fluid. Electrochemical devices may be operated to promote one or more electrochemical reactions specifically designed to achieve or enhance separation performance. For instance, electrochemical devices may drive ion transport in a specific direction through selectively permeable membranes by allowing ion transport in a specific direction, and preventing ion transport in another specific direction. In certain embodiments, electrochemical devices may comprise electrically active membranes, such as semi-permeable or selectively permeable ion exchange or bipolar membranes.

Electrodeionization (EDI) systems may further employ electrically active media to separate the one or more ionized or ionizable species from the fluid. The electrically active media typically serves to alternately collect and discharge ionic and/or ionizable species and, in some cases, to facilitate the transport of ions. The transport of ions may occur continuously, for instance by ionic or electronic substitution mechanisms. EDI devices may comprise electrochemically active media of permanent or temporary charge, and may be operated batch-wise, intermittently, continuously, and/or even in reversing polarity modes.

One embodiment of EDI is continuous electrodeionization (CEDI). CEDI devices are EDI devices known to those skilled in the art that operate in a manner in which water purification can proceed continuously, while ion exchange material is continuously recharged. CEDI techniques may include processes such as continuous deionization, filled cell electrodialysis, or electrodiaresis. Under specific controlled voltage and salinity conditions in CEDI systems water molecules may be split to generate hydrogen or hydronium ions or species and hydroxide or hydroxyl ions or species that can regenerate ion exchange media in the device and thus facilitate the release of the trapped species therefrom. In this way, a water stream to be treated may be continuously purified without requiring chemical recharging of ion exchange resin.

Electrodialysis (ED) devices operate similarly to EDI devices (i.e. alternately collecting and discharging species in batch-wise processes, intermittently, continuously, or in reversing polarity modes). However, ED devices typically do not contain electroactive media between the membranes. Because of the lack of electroactive media, the operation of ED devices may be hindered on feed waters of low salinity having an elevated electrical resistance. Also, because the operation of ED on high salinity feed waters can result in elevated electrical current consumption, ED devices have heretofore been most effectively used on source waters of intermediate salinity. In ED based systems, because there is no electroactive media, splitting water is inefficient and operating in such a regime is generally avoided.

In certain electrochemical separation devices, such as those employed in systems and methods disclosed herein, a plurality of adjacent cells or compartments may be separated by selectively permeable membranes that allow the passage of either positively or negatively charged species, but typically not both. Dilution or depletion compartments are typically interspaced with concentrating or concentration compartments in such devices. As water flows through the dilution compartments, ionic and other charged species may be drawn into concentration compartments under the influence of an electric field, such as a DC field. Positively charged species may be drawn toward a cathode, generally located at one end of a stack of multiple dilution and concentration compartments. Negatively charged species may be drawn toward an anode of such devices, generally located at the opposite end of the stack of compartments. The electrodes may be housed in electrolyte compartments that are generally partially isolated from fluid communication with the dilution and/or concentration compartments. Once in a concentration compartment, charged species may be trapped by a barrier of selectively permeable membranes, at least partially defining the concentration compartment. For example, anions may be prevented from migrating further toward the cathode, out of the concentration compartment, by a cation selective membrane. Similarly, cations may be prevented from migrating further toward the anode, out of the concentration compartment, by an anion selective membrane. Once captured in the concentration compartment, trapped charged species may be removed in a concentrate reject stream.

In electrochemical separation devices, the electric field is generally applied to the compartments from a source of voltage and electric current applied to the first and second electrodes. The voltage and current source, referred to herein collectively as the “power supply,” may be itself powered by a variety of systems, such as an AC power source, or, for example, a power source derived from solar, wind, or wave power.

At the electrode-liquid interfaces, electrochemical half-cell reactions may occur that initiate and/or facilitate the transfer of ions through the membranes and compartments. The specific electrochemical reactions that occur at the electrode and membrane interfaces may be partially controlled by ionic concentration in the specialized compartments that house the electrode assemblies.

Fouling of ion exchange membranes typically occurs during operation of electrochemical separation devices. Exemplary foulants include colloids, organic molecules, precipitated inorganic compounds (such as CaCO₃), and other contaminants. In exemplary processes including desalination of surface waters, treatment of municipal wastewaters, treatment of certain industrial wastewaters, and process streams in food production, organic fouling is a risk. Organic molecules, which are predominantly negatively charged in water, are typically transported in the diluting compartment by the applied power source, for example, DC field, to the anion exchange membranes. Depending on the properties of the molecules (for example, structure, molecular weight, charge, concentration, an others) and the properties of the membrane (for example, structure, hydrophobicity, charge density, water content, and others) the organic molecules may be transported through the membranes under the electric field, adsorbed onto the membrane surfaces by electrostatic interactions, or deposited on the membranes in “gel layers.”

Fouling may affect the resistance of the membranes and the adjacent diffusion layers. Fouling may have a detrimental effect on current efficiency, desalination rate, and energy consumption rate of the electrochemical separation device. Conventionally, polarity and flow reversal processes are employed to mitigate fouling. The method is often referred to as electrodialysis reversal (EDR). During EDR, typically the direction of ion flow is reversed by reversing the polarity of the applied electric current. The reversal of ion flow generally reduces electric resistance of the electrochemical separation device. However, fluid flow reversal through the device may be required to flush out accumulated ions. As a result, polarity and flow reversal may contribute significantly to system downtime and water loss.

Another conventionally practiced method to mitigate fouling includes applying a pulsed electric field. For example, a pulsed DC electric field may be applied in a frequency between 30-100 Hz. The frequency generally depends on the type and concentration of the foulants. The pulsed electric field may decrease electric resistance by enhancing mobility of the charged particles in the fouling layer. However, applying a pulsed electric field is not typically sufficient to reduce electric resistance to a baseline resistance.

Regular maintenance of an electrochemical separation device includes periodic chemical cleaning. Generally, a chemical cleaning may be performed to remove fouling and reset electrical resistance to a starting resistance. Chemical cleaning, sometimes referred to as “clean in place” or “CIP” maintenance, typically involves a chemical backwash of the membrane modules to remove fouling. Chemical cleaning methods typically require that the electrochemical separation device be placed offline for maintenance. With any electrochemical separation process, common costs associated with systems include CIP frequency and system downtime. A reduction in CIP frequency and downtime may improve water treatment yields by the system.

During testing on effluent from a municipal wastewater plant it was observed that the overall electrical resistance tends to increase with operation at a faster rate than the baseline resistance, even when conventional methods to limit fouling (for example, polarity and flow reversal and pulsed electric current) were applied. As such, CIP frequency and system downtime is still higher than desired.

The systems and methods disclosed herein involve a periodic regeneration of the electrochemical separation device in a passive mode. The periodic regeneration may reduce, delay, limit, or inhibit fouling of the membrane. The periodic regeneration may reduce a rate of resistance increase during operation. The periodic regeneration may reduce frequency of CIP and/or increase overall system operation time by preventatively reducing, delaying, limiting, or inhibiting fouling. The periodic regeneration may reduce frequency or avoid non-scheduled CIP. The periodic regeneration may increase current efficiency, lowering energy costs. In systems including more than one electrochemical separation device, overall product flow may be uninterrupted and recovery unaffected by nonsimultaneously performing periodic regeneration and CIP.

Thus, in accordance with at least one embodiment, systems and methods for reducing, delaying, limiting, or inhibiting fouling of an electrochemical separation device are described herein. In accordance with at least one embodiment, the operating time of an electrochemical separation device between chemical cleaning steps may be increased by applying the systems and methods disclosed herein, as compared to (or when combined with) conventional methods of mitigating fouling. For instance, the operating time between chemical cleaning steps may be extended to at least about 65 days, compared to 10-12 days under conventional methods. Additionally or alternatively, in accordance with at least one embodiment, the downtime of an electrochemical separation device may be decreased by applying the systems and methods disclosed herein, as compared to (or when combined with) conventional methods of mitigating fouling.

Thus, in accordance with one aspect, a method of operating an electrochemical separation device is provided. The method may include cycling between active modes of operation and passive modes of regeneration of the electrochemical separation device. The electrochemical separation device may be an ED, EDI, CEDI, or other electrochemical device. The ED may be, for example, of a plate and frame, cross flow, or spiral configuration. The systems and methods may be performed for a variety of feed water qualities being directed to the electrochemical separation device. The systems and methods may be performed on a variety of types of ion exchange membranes, for example, for various functional groups or chemistries, and a devices having various number and/or configurations of the membranes. The methods may be performed for any number of electrochemical separation devices in a system and the systems may contain one or more electrochemical separation devices. Furthermore, the systems and methods may be implemented on a plurality of electrochemical separation devices positioned in series or in parallel.

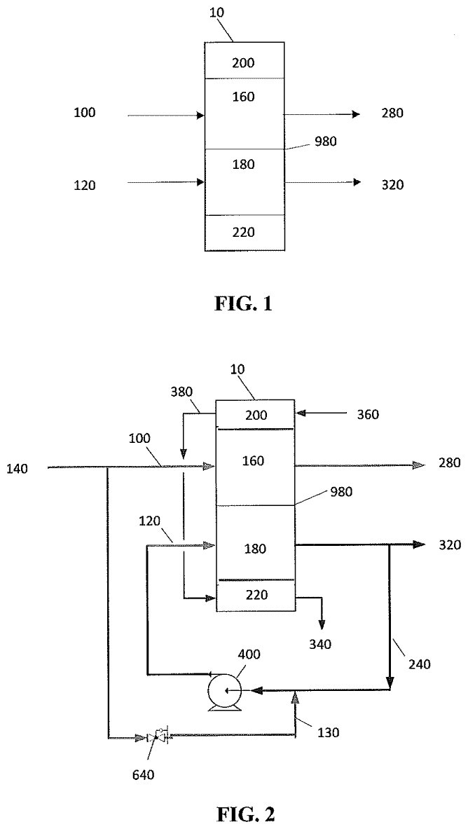

The electrochemical separation device may comprise a dilution compartment, a concentration compartment, an ion exchange membrane positioned between the dilution compartment and the concentration compartment, and first and second electrodes. FIG. 1 is a schematic drawing of an exemplary electrochemical separation device. The electrochemical separation device 10 of FIG. 1 includes dilution compartment 160, concentration compartment 180, ion exchange membrane 980, and first and second electrodes 200, 220. The electrochemical separation device 10 is fluidly connected to first fluid line 100 and second fluid line 120. The electrochemical separation device 10 is also fluidly connected to product line 280 and reject line 320.

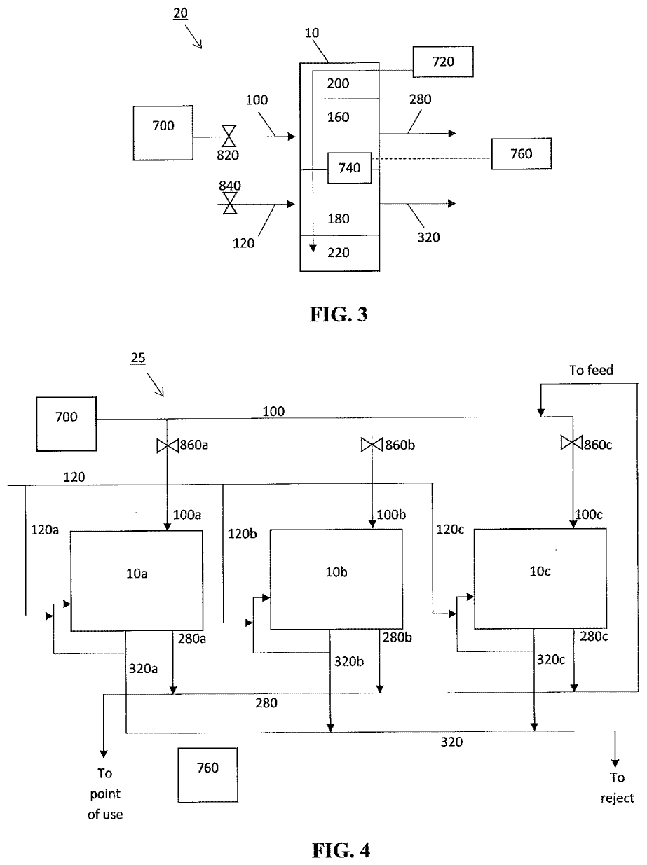

FIG. 2 is a schematic drawing of an exemplary water treatment system including electrochemical separation device 10. The system of FIG. 2 comprises an electrochemical separation device 10 comprising a dilution compartment 160 having an inlet (adjacent to feed line 100) and a product outlet (adjacent to product line 280), a concentration compartment 180 having an inlet (adjacent to feed line 120) and a reject outlet (adjacent to reject line 320), an ion exchange membrane 980 positioned between the dilution compartment 160 and the concentration compartment 180, and first and a second electrodes 200, 220 positioned at distal ends of the electrochemical separation device 10. The system may comprise an electrode feed 360, electrode reject 340, and electrode line 380 fluidly connecting the first and second electrodes 200, 220. The system comprises a first feed line 100 fluidly connected to the dilution compartment 160 and a second feed line 120, 130 fluidly connected to the concentration compartment 180. The second feed line may comprise an upstream end 130 and a downstream end 120. The downstream end of the second feed line 120 may be connected to the concentration compartment. The upstream end of the second feed line 130 may be connected to a feed inlet. First and second feed lines, 100 and 130, respectively, may split from a general feed line 140. Second feed line 130 comprises a valve 640 configured to allow the feed stream to reach the concentration compartment 180, through recycle line 240. The recycle line 240 may be fluidly connected to the reject outlet 320 and the concentration compartment 180. The recycle line may further comprise a pump 400 configured to pump the concentrate reject and/or second feed stream to the concentration compartment 180.

Systems and methods may be configured to operate the electrochemical separation device in an active mode. As disclosed herein, the active mode may include those modes of operation which produce electrochemically treated water as product. For instance, the active mode may generally include transmitting current between the electrodes. The active mode may include directing feed streams to the dilution compartment and to the concentration compartment. The active mode may include producing a product stream through the dilution compartment and producing a reject stream through the concentration compartment. The product stream and the reject stream may be directed away from the dilution compartment and the concentration compartment, respectively. In general, the product stream may be directed to a post-treatment process and/or a point of use. In some embodiments, the product may be recycled to the feed stream or to a feed stream of another electrochemical separation device. The reject stream may be directed to a post-treatment process, discarded, and/or recycled back to the concentration compartment.

The methods may comprise operating the electrochemical separation device in the active mode for a first period of time. The first period of time may generally be an amount of time sufficient to increase resistance in the electrochemical separation device to a threshold resistance. The first period of time may be predetermined or preset. In other embodiments, the first period of time may be dependent on a determined resistance during operation. The period of time may depend on parameters such as quality of the feed stream and degree of fouling of the membrane. For instance, the period of time may be lesser during treatment of a feed stream with a higher concentration of total organic carbon (TOC), total dissolved solids (TDS), or total suspended solids (TSS). A typical concentration of TOC in the feed water may be, for example, between 5-12 ppm. In embodiments wherein the organic foulants are of concern, the measured parameter is generally TOC. A typical concentration of TDS in feed water may be, for example, between 500-800 ppm. The period of time may be lesser when the membrane has a greater amount of foulant build up.

The period of time for active operation may be between about 6 hours and about 60 hours. The first period of time may be between about 12 hours and about 48 hours. The period of time may be between about 24 hours and about 48 hours. The period of time may be about 6 hours, 12 hours, about 18 hours, about 24 hours, about 30 hours, about 36 hours, about 42 hours, about 48 hours, about 54 hours, or about 60 hours.

Operation in the active mode may be dependent on a measured or otherwise determined resistance during operation. Thus, in certain embodiments, the systems and method may involve determining a resistance in the electrochemical separation device. The resistance may be measured by a resistance sensor. For instance, an ohmmeter may be used to measure resistance. The resistance may be determined by measuring conductivity between the electrodes. For instance, the resistance may be calculated from a measurement obtained by a conductivity sensor. The resistance may be determined by selecting or measuring electric current and/or voltage. The electric current and/or voltage may be supplied by a power source.

The method may comprise operating the electrochemical separation device in the active mode until a resistance in the electrochemical separation device reaches a threshold. The threshold may be predetermined or pre-selected. In general, the threshold resistance may be a resistance at which regeneration of the electrochemical separation device may be appropriate or useful. A user or operator may select the threshold resistance based on system parameters and/or performance. As disclosed herein, resistance refers to electrical resistance. In certain embodiments, the threshold resistance may be at least about 10 ohm greater than a starting or baseline resistance. The threshold resistance may be at least about 15 ohm, about 20 ohm, about 25 ohm, about 30 ohm, about 35 ohm, about 40 ohm, about 45 ohm, or about 50 ohm greater than a starting or baseline resistance.

The starting resistance may generally refer to the electrochemical resistance when substantially no fouling is present on the membrane. The starting resistance may be a resistance upon initial start of operation, for example, when the electrochemical separation device is placed online. The starting resistance may be a resistance immediately following a chemical cleaning operation. The starting resistance may be a resistance immediately preceding active mode operation.

The baseline resistance may generally refer to a reference line resistance defined by a gradual increase in resistance from the starting resistance to a resistance at which a chemical clean of the electrochemical separation device may be appropriate or useful. The baseline resistance may be substantially linear over time. For instance, the baseline resistance may be defined by a gradual linear increase over time from the starting resistance. The baseline resistance may have a gradual linear increase of less than about 10 ohm/day. The baseline resistance may have a gradual linear increase of less than about 8 ohm/day, less than about 6 ohm/day, less than about 5 ohm/day, less than about 4 ohm/day, less than about 2 ohm/day or less than about 1 ohm/day.

The systems and methods may involve determining the average resistance in the electrochemical separation device. Determining the average resistance may include determining the resistance as previously described, for a preselected time period. Thus, in some embodiments, the average resistance may be determined by the day, hour, or minute. Any of the methods disclosed herein may be performed by considering average resistance.

In accordance with certain embodiments, the threshold resistance may be at least about 10 ohm/day greater than a starting or baseline resistance. The threshold resistance may be at least about 15 ohm/day, about 20 ohm/day, about 25 ohm/day, about 30 ohm/day, about 35 ohm/day, about 40 ohm/day, about 45 ohm/day, or about 50 ohm/day greater than a starting or baseline resistance.

In accordance with certain embodiments, the threshold resistance may be at least about 10 ohm/hr greater than a starting or baseline resistance. The threshold resistance may be at least about 15 ohm/hr, about 20 ohm/hr, about 25 ohm/hr, about 30 ohm/hr, about 35 ohm/hr, about 40 ohm/hr, about 45 ohm/hr, or about 50 ohm/hr greater than a starting or baseline resistance.

In accordance with certain embodiments, the threshold resistance may be at least about 10 ohm/min greater than a starting or baseline resistance. The threshold resistance may be at least about 15 ohm/min, about 20 ohm/min, about 25 ohm/min, about 30 ohm/min, about 35 ohm/min, about 40 ohm/min, about 45 ohm/min, or about 50 ohm/min greater than a starting or baseline resistance.

Operation in the active mode may be dependent on a measured or otherwise determined amount or rate of fouling. Thus, in certain embodiments, the systems and method may involve determining or estimating an amount or rate of fouling in the electrochemical separation device. Fouling may be determined by pressure drop in the electrochemical separation device. For instance, a pressure sensor may be used to measure pressure drop. Pressure drop may be proportionately correlated to an amount of fouling. Thus, the methods may comprise measuring pressure or pressure drop within the electrochemical cell. Additionally or alternatively, fouling may be estimated by measuring composition of the feed stream and/or product or discharge stream. Fouling may be estimated by measuring flow rate in or out of the electrochemical cell. For a known composition at a known flow rate, the rate of fouling may be estimated. The methods may comprise measuring one or more of composition and flow rate of a process stream.

Systems and methods may be configured to regenerate the electrochemical separation device in an passive mode. As disclosed herein, the passive mode may include those modes of operation which contribute to regeneration of the electrochemical separation device by substantially ceasing active operation. For instance, the passive mode may generally include suspending transmission of current between the electrodes. The passive mode may include blocking feed streams from the dilution compartment and the concentration compartment. The passive mode may include soaking the membrane with fluid held in the dilution and concentration compartments. The membranes may be soaked with process water, feed water, or fresh water. In some embodiments, the membranes may be soaked with product water from the electrochemical separation device or from another electrochemical separation device. The passive mode may include a suspension of operation in the active mode.

The methods may comprise regenerating the electrochemical separation device in a passive mode for a second period of time. The second period of time may generally be an amount of time sufficient to decrease resistance in the electrochemical separation device to the baseline resistance. The second period of time may be predetermined or preset. In some embodiments, the second period of time may be selected based on a determined resistance at the time of switching from the active mode to the passive mode. The period of time may depend on parameters such as quality of the feed stream and degree of fouling of the membrane. For instance, the period of time for regeneration may be greater during treatment of a feed stream with a higher concentration of total dissolved solids (TDS) or total suspended solids (TSS). The period of time for regeneration may be greater when the membrane has a greater amount of foulant build up.

The period of time for passive regeneration may be between about 6 hours and about 24 hours. The period of time for passive regeneration may be between about 6 hours and about 36 hours. The period of time for passive regeneration may be between about 3 hours and about 48 hours. The period of time for passive regeneration may be about 3 hours, about 6 hours, about 9 hours, about 12 hours, about 15 hours, about 18 hours, about 21 hours, about 24 hours, about 30 hours, about 36 hours, or about 48 hours.

The method may comprise regenerating the electrochemical separation device in a passive mode until the resistance reaches a second threshold lower than the first threshold (lower than the active mode operation threshold). The threshold may be predetermined or pre-selected. In general, the threshold resistance may be at or about the baseline resistance. The threshold resistance may be resistance at which operation of the electrochemical separation device in the active mode may be appropriate or useful. The second (or regeneration) threshold may be at least about 10 ohm less than the first (or active mode) threshold. The second threshold may be at least about 5 ohm, about 10 ohm, about 15 ohm, about 20 ohm, about 25 ohm, or about 50 ohm less than the first threshold.

The second threshold may be an average threshold. For instance, the second threshold may be at least about 10 ohm/day less than the first threshold. The second threshold may be at least about 5 ohm/day, about 10 ohm/day, about 15 ohm/day, about 20 ohm/day, about 25 ohm/day, or about 50 ohm/day less than the first threshold. The second threshold may be at least about 10 ohm/hr less than the first threshold. The second threshold may be at least about 5 ohm/hr, about 10 ohm/hr, about 15 ohm/hr, about 20 ohm/hr, about 25 ohm/hr, or about 50 ohm/hr less than the first threshold. The second threshold may be at least about 10 ohm/min less than the first threshold. The second threshold may be at least about 5 ohm/min, about 10 ohm/min, about 15 ohm/min, about 20 ohm/min, about 25 ohm/min, or about 50 ohm/min less than the first threshold.

In accordance with certain embodiments, regeneration in the passive mode may include flushing at least one of the dilution compartment and the concentration compartment. Flushing of the compartments may be performed at the transition between operation and regeneration, during regeneration, or at the transition between regeneration and operation. The compartments may be flushed with process water or fresh water. The compartments may be flushed with feed water. The compartments may be flushed with product water, for example, with product water from the electrochemical separation device or another electrochemical separation device. In some embodiments, flushing the compartment may comprise a flow reversal. The methods may comprise reversing flow of the process streams for a period of time during the regeneration.

In accordance with certain embodiments, regeneration in the passive mode may include dosing with a salt solution or a chemical solution to enhance removal of fouling. The dosing may follow a flush of the one or more compartments. The dosing may be performed before a flush of the one or more compartments. In some embodiments, the dosing may be performed during a first half or first quarter of the regeneration, to maximize removal of fouling. The dosing may be performed prior to soaking the membrane for the remainder of the regeneration.

In accordance with certain embodiments, the methods may comprise pulsing electric charge during the regeneration. For instance, electric charge may be pulsed during soaking. In certain embodiments, the method may comprise pulsing DC charge during the regeneration, for example, during a soak. The methods may comprise providing a minimal electric charge during regeneration. As disclosed herein, providing a minimal charge may be referred to as “trickling” electric charge or current. The electric charge may be trickled during soaking. The electric charge may be trickled during regeneration.

Systems and methods may be configured to resume operation of the electrochemical separation device in the active mode. For example, a control module may instruct the electrochemical separation device to resume operation upon regeneration of the device and/or completion of the passive mode. The active mode of operation may proceed as previously described. The methods may comprise resuming operation of the electrochemical separation device in the active mode for a period of time. The period of time may be pre-set or predetermined, as previously described. The period of time may generally be an amount of time sufficient to increase resistance in the electrochemical separation device to a threshold resistance, as previously described.

The period of time for active operation may be between about 6 hours and about 60 hours. The first period of time may be between about 12 hours and about 48 hours. The period of time may be between about 24 hours and about 48 hours. The period of time may be about 6 hours, 12 hours, about 18 hours, about 24 hours, about 30 hours, about 36 hours, about 42 hours, about 48 hours, about 54 hours, or about 60 hours.

The threshold resistance may generally be greater than the regeneration threshold resistance. Due to the progression of operation and the gradual increase of the baseline resistance over time, the threshold resistance may generally be equal to or greater than the threshold resistance for a previous operation in the active mode. In accordance with certain embodiments, the threshold may be equal to the threshold resistance for a previous operation in the active mode. In other embodiments, the threshold resistance may be unequal to the threshold resistance for a previous operation in the active mode. In some embodiments, the threshold resistance may be greater than the threshold resistance for a previous operation in the active mode.

In certain embodiments, the threshold resistance may be at least about 10 ohm greater than a starting or baseline resistance. The threshold resistance may be at least about 15 ohm, about 20 ohm, about 25 ohm, about 30 ohm, about 35 ohm, about 40 ohm, about 45 ohm, or about 50 ohm greater than a starting or baseline resistance. The threshold resistance may be an average resistance per day, hour, or minute, as previously described.

The methods may comprise performing a chemical clean on the electrochemical separation device. In general, the systems and methods may be configured to continue cycling between an active mode and passive mode until a chemical clean is to be performed. The chemical clean may be performed after cycling through modes of operation for a period of time. The period of time may be pre-selected or predetermined. The chemical clean may be performed until the resistance reaches a threshold resistance. The chemical clean threshold resistance may be about 300 ohm greater than a starting resistance. The chemical clean threshold resistance may be about 350 ohm, about 400 ohm, about 450 ohm, or about 500 ohm greater than a starting resistance. In some embodiments, the chemical clean may be performed periodically. For example, the chemical clean may be performed once a week, bi-weekly, once every three weeks, monthly, once every six weeks, bi-monthly, once every ten weeks, or once every twelve weeks.

The methods may comprise reversing polarity of the first and second electrodes. The polarity reversal may be accompanied by a flow reversal, as previously described. The polarity reversal may be performed periodically. For instance, the polarity reversal may be performed daily, twice-weekly, weekly, bi-weekly, every three weeks, or monthly. The polarity reversal may be performed after a regular number of cycles. For example, the polarity reversal may be performed every cycle, every two cycles, every three cycles, every four cycles, every five cycles, or every ten cycles.

Water treatment systems comprising an electrochemical separation device are disclosed herein. FIG. 3 is a schematic drawing of an exemplary water treatment system 20. The water treatment system 20 includes electrochemical separation device 10, as previously described. Water treatment system 20 is fluidly connectable to a source of water to be treated 700. Electrodes 200, 220 are electrically connectable to power source 720. Water treatment system 20 may be fluidly connectable to a source of a salt solution or chemical clean.

Water treatment system 20 comprises a conductivity sensor 740 positioned to measure conductivity in the electrochemical separation device 10. Conductivity sensor 740 may be electrically connected to control module 760. Conductivity sensor 740 may be or comprise, for example, an electrode conductivity sensor, an inductive conductivity sensor, a conductivity/resistivity sensor, or an ohmmeter. The conductivity sensor may be used to determine electrical resistance within the electrochemical separation device. Briefly, electrical resistance is the inverse of electrical conductance. The conductivity sensor may be positioned to measure conductivity of a solution within the electrochemical separation device. The conductivity sensor may be positioned to measure conductivity of the feed stream. The conductivity sensor may be positioned to measure conductivity of the product stream.

Water treatment systems may comprise one or more sensor electrically connected to control module 760. Sensors may include, for example, sensors configured to measure flow rate of at least one of fluid in the feed lines, sensors configured to measure composition of at least one of fluid in the feed lines or at an outlet, and sensors configured to measure pressure or pressure drop in at least one of the concentration compartment and the dilution compartment.

The flow rate sensor may be any flow meter known to one of ordinary skill in the art. For instance, the flow rate sensor may be or comprise a liquid flow meter, a mechanical flow meter, a pressure-based flow meter, a vortex flow meter, or others. The flow rate may be considered to estimate an amount of fouling on the membrane. For instance, for a given inlet water quality, fouling rate may be estimated from inlet flow rate of the water to be treated. Inlet flow rate and outlet flow rate may also be considered in determining whether to place an electrochemical separation device offline. For instance, below a threshold flow rate, one or more electrochemical separation devices may be placed offline to improve energy efficiency.

The composition sensor may be positioned to measure composition of feed water or effluent (product or discharge). The composition sensor may be configured to measure concentration of one or more of TSS, TDS, total organic carbon (TOC), dissolved oxygen or oxygenated species, chlorine species, sulfur species, phosphate species, or any other component of interest. In particular, a component of interest may be one that contributes to membrane fouling. The components of interest may be organic foulants or inorganic foulants. The composition may be considered to estimate an amount of foulant on the membrane, independently from or in conjunction with consideration of the flow rate.

The pressure sensor may be positioned to measure pressure drop within the electrochemical separation device. Pressure drop may be an indication of fouling on the membrane. Measurements from the pressure sensor may trigger the control module to perform one or more of regeneration in the passive mode, polarity reversal, flow reversal, and chemical clean. Furthermore, measurements from the pressure sensor may indicate to the control module that the electrochemical separation device is ready to resume operation in the active mode.

The control module 760 may be operatively connected to electrodes 200, 220. The control module may be operatively connected to valves 820, 840 positioned in feed lines 100, 120, respectively. The control module 760 may be configured to operate the electrochemical separation device 10 in the active mode or passive mode, and to transition the electrochemical separation device 10 between modes. For instance, the control module 760 may be configured to suspend transmission of current between the first and second electrodes 200, 220 and close the dilution compartment inlet and the concentration compartment inlet (via valves 820, 840, respectively) responsive to a measurement obtained by the sensor 740 reaching a threshold value. The control module 760 may be configured to resume transmission of the current and open the dilution compartment inlet and the concentration compartment inlet (via valves 820, 840) after a predetermined period of time. The control module may be configured to perform one or more operation during the passive mode, for example, flush the compartments, reverse flow, provide a salt solution or a chemical clean, and pulse electric current. The control module may be configured to perform additional maintenance operations, when appropriate, for example, polarity reversal, flow reversal, and CIP.

The control module may be or comprise any electronic or computing device known to one of ordinary skill in the art. The control module may include input devices, for example, a touch pad, a touch screen, a key pad, a keyboard, a microphone, and/or a mouse. The control module may include output devices, for example, a screen, a light (for example, an LED light), and/or a speaker. The control module may be electrically or operatively connected to the one or more components via a wire or wireless connection. The control module and each of the components may be electrically or operatively connected via an internet connection, for example, a Wi-Fi, or Bluetooth connection. Optionally, the connection may be made to a server or directly between components. The control module may be electrically connected to a power source.

Water treatment systems comprising two or more electrochemical separation devices are disclosed herein. FIG. 4 is a schematic diagram of a water treatment system according to an alternate embodiment. The water treatment system 25 includes three electrochemical separation devices 10a, 10b, and 10c. However, water treatment systems may include more or less electrochemical separation devices. The two or more electrochemical separation devices 10a, 10b, and 10c are each individually connected to feed line 100 and feed line 120 through conduits 100a, 100b, 100c, 120a, 120b, and 120c, respectively. Product lines 280a, 280b, 280c may be fluidly connected to feed lines to provide product water for soaking or flushing. Reject lines 320a, 320b, 320c may be recycled to the concentration compartment.

Control module 760 may be configured to control operation of each electrochemical separation device 10a, 10b, and 10c independently. For example, control module 760 may be operatively connected to valves 860a, 860b, and 860c. In certain embodiments, control module 760 is configured to suspend transmission of the current and close the dilution compartment inlet and the concentration compartment inlet nonsimultaneously. For instance, control module 760 may be configured to maintain at least one of electrochemical separation devices 10a, 10b, and 10c operating in an active mode at any given time. Control module 760 may be configured to maintain at least one of electrochemical separation devices 10a, 10b, and 10c regenerating in a passive mode at any given time.

Transitions between active mode and passive mode may be controlled so as to control introduction of the feed streams or output of the product. In some embodiments, the control module 760 may control operation of the electrochemical separation devices 10a, 10b, and 10c such that one or more of feed stream flow rate, product flow rate, and discharge flow rate remain substantially constant. Control module 760 may communicate with one or more flow sensors and valves (shown in FIG. 3) to control flow rate.

Systems and methods for facilitating operation of an electrochemical separation device are disclosed herein. The methods may comprise providing a control sequence configured to instruct the control module to operate the electrochemical separation device in the active mode and/or passive mode. In particular, the control sequence may be configured to instruct the control module to operate the electrochemical separation device by cycling between the active mode and the passive mode, as previously described.

The control sequence may instruct operation in each of the modes for predetermined periods of time, as previously described. In some embodiments, the control sequence may instruct operation of the electrochemical separation device in the active mode or passive mode responsive to a conductivity measurement obtained by a sensor.

The methods disclosed herein may comprise providing one or more component of the system. For instance, the methods may comprise providing one or more sensor, as previously described. The methods may comprise providing a control module. The methods may comprise programming the control module, for example, with the control sequence described herein. The methods may comprise installing any one or more of the components described herein, for example, any one or more sensor or the control module.

The methods may comprise providing instructions or instructing a user to operate the system by any of the methods described herein. In certain embodiments, the methods may comprise instructing a user to select at least one threshold resistance and/or predetermined period of time, as previously described.

### EXAMPLES

The function and advantages of these and other embodiments can be better understood from the following examples. These examples are intended to be illustrative in nature and are not considered to be limiting the scope of the invention. In the following examples, electrochemical separation devices can be regenerated by the systems and methods disclosed herein.

### Prophetic Example 1: Cycling Between Active and Passive Modes

An operating sequence for an electrochemical separation device may include operating the electrochemical separation device in an active mode for a predetermined period of time, with or without polarity and flow reversal. Optionally, the electrochemical separation device may be operated with the concentrate stream recirculated in a cyclic batch mode. The active mode may be followed by regeneration in the passive mode, including suspending DC power. The regeneration may include, following suspension of power, a series of one or more flow reversals to flush the dilute and concentrate compartments and promote dissolution and diffusion of foulants away from the membrane surfaces. Operation may be resumed in the active mode with DC power back on.

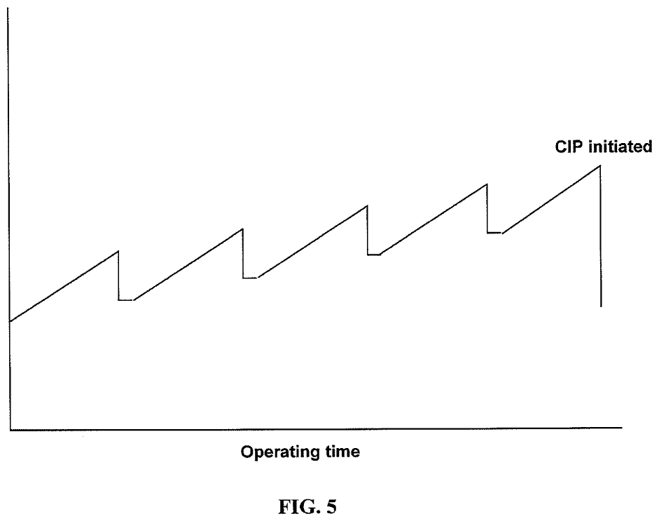

FIG. 5 is a modeled graph showing behavior of resistance of an electrochemical separation device over time during operation as described in prophetic example 1. As shown in the graph of FIG. 5, resistance increases during active operation and decreases to a baseline during passive regeneration in a sawtooth pattern. The baseline resistance may increase continuously even during a series of regeneration sequences. A CIP may be carried out when the baseline resistance increases to an upper limit.

### Prophetic Example 2: Dosing with a Chemical Cleaning Solution and/or Salt Solution

An operating sequence for an electrochemical separation device may include operating the electrochemical separation device in an active mode for a predetermined period of time, as generally described in prophetic example 1. The active mode may be followed by regeneration in the passive mode, including suspending DC power and flow to the dilution and concentration compartments. A chemical cleaning solution and/or salt solution may be injected into the dilution and/or concentration compartment either immediately before or at the beginning of the regeneration. The compartments and/or membranes may be soaked for a predetermined period of time during the regeneration. Feed streams to the dilution and concentration compartment may be flushed with water, for example, feed water or product water from storage or another electrochemical separation device operating in the active mode. Operation may be resumed in the active mode with DC power back on.

### Prophetic Example 3: Maintaining a Low Electric Current During Regeneration

An operating sequence for an electrochemical separation device may include operating the electrochemical separation device in an active mode for a predetermined period of time, as generally described in prophetic example 1. The active mode may be followed by regeneration in the passive mode, including suspending flow to the dilution and concentration compartments. A trickle current may be maintained during the regeneration to increase dissolution rate of foulants. A chemical cleaning solution or salt solution may be injected into the dilution and/or concentration compartment either immediately before or at the beginning of the regeneration. The compartments and/or membranes may be soaked for a predetermined period of time during the regeneration. Feed streams to the dilution and concentration compartment may be flushed with water, for example, feed water or product water from storage or another electrochemical separation device operating in the active mode. Operation may be resumed in the active mode with an operating DC power back on.

### Prophetic Example 4: Soaking Dilution and Concentration Compartments

An operating sequence for an electrochemical separation device may include operating the electrochemical separation device in an active mode for a predetermined period of time, as generally described in prophetic example 1. The active mode may be followed by regeneration in the passive mode, including suspending DC power and flow to the dilution and concentration compartments. The dilution compartment and concentration compartment may be filled with feed water or product from the electrochemical separation device or another operating electrochemical separation device either immediately before or at the beginning of the regeneration. The compartments and/or membranes may be soaked for a predetermined period of time during the regeneration. Optionally, DC power may be pulsed periodically during the soak to increase dissolution rate of the fouling. Operation may be resumed in the active mode with an operating DC power back on.

### Example 1

An electrodialysis device was operated to treat municipal wastewater. The compositions and parameters of the feed water, product water, and concentrate are shown in Tables 1A-1B, below. Additionally, the feed water had high and unpredictable concentrations of TSS. While not wishing to be bound by theory, it is believed that high and unpredictable concentrations of TSS contributed to particulate levels and sludge that presented challenges during pretreatment, prior to treatment with the electrochemical separation device.

TABLE 1A
Parameters of feed water, product water, and concentrate streams

| | | | Product water | Concentrate | Concentrate |
|---|---|---|---|---|---|
| | | | (82.5% | (82.5% | (68% |
| Parameter | Feed water | Feed water | recycled) | recycled) | recycled) |
| Ca (as CaCO₃) | 191 | 181 | 63.8 | 783 | 301 |
| (ppm) | | | | | |
| M (as CaCO₃) | 35.8 | 33.6 | 13.4 | 137 | 54.3 |
| (ppm) | | | | | |
| Na (as CaCO₃) | 254 | 243 | 156 | 666 | 331 |
| (ppm) | | | | | |
| K (as CaCO₃) | 23 | 21 | 11 | 72 | 34 |
| (ppm) | | | | | |
| Fe (ppm) | 0.036 | 0.044 | 0.036 | 0.051 | 0.057 |
| Mn (ppm) | 0.02 | 0.019 | 0.009 | 0.075 | 0.034 |
| Al (ppm) | 0.007 | 0.012 | 0.007 | 0.026 | 0.007 |
| Ba (ppm) | 0.05 | 0.047 | 0.014 | 0.193 | 0.086 |
| Sr (ppm) | 0.476 | 0.432 | 0.148 | 1.83 | 0.737 |
| Cu (ppm) | 0.2 | <0.002 | <0.002 | <0.002 | <0.002 |
| Zn (ppm) | 0.074 | 0.056 | 0.045 | 0.137 | 0.077 |
| Bicarbonate | 252.6 | 247 | 149.5 | 712.2 | 351.5 |
| (as CaCO₃) | | | | | |
| (ppm) | | | | | |
| F (as CaCO₃) | 0.524 | 1.23 | 0.711 | 1.53 | 1.74 |
| (ppm) | | | | | |
| Cl (as CaCO₃) | 102 | 121 | 54.1 | 455 | 199 |
| (ppm) | | | | | |
| Br (as CaCO₃) | 0.358 | 0.234 | 0.18 | 1.76 | 0.308 |
| (ppm) | | | | | |
| NO₃ (as CaCO₃) | 5.74 | 7.7 | 3.29 | 28.7 | 10.5 |
| (ppm) | | | | | |
| PO₄ (as CaCO₃) | 18.3 | 15.1 | 7.82 | 49.1 | 24.4 |
| (ppm) | | | | | |
| Sulfate (as CaCO₃) | 78.4 | 97.8 | 32.4 | 437 | 170 |
| (ppm) | | | | | |
| Silica (ppm) | 25.9 | 26.2 | 26.5 | 25.7 | 26.1 |
| pH (sample) | 7.16 | 7.33 | 7.05 | 7.57 | 7.59 |
| pH (in field) | 7.56 | — | — | — | 7.4 |
| Turbidity | 0.27 | 0.288 | 0.047 | 54.9* | 0.344 |
| (NTU) | | | | | |
| Conductivity | 965 | 930 | 477 | 2863 | 1393 |
| (uS/cm) | | | | | |
| Conductivity | 876 | — | — | — | — |
| (in field) | | | | | |
| (uS/cm) | | | | | |
| Total hardness | 226.4 | 214.6 | 77.13 | 919.7 | 355.3 |
| (ppm) | | | | | |
| Temperature | 12.2 | 15 | 15 | 15 | 15 |
| (° C.) | | | | | |
| TDS (by | — | 590 | 245 | 1854 | — |
| evaporation) | | | | | |
| (ppm) | | | | | |
| TOC (ppm) | 8.53 | 10.041 | 8.897 | 15.4 | 10.95 |
| Free chlorine | — | — | — | — | — |
| (ppm) | | | | | |

*suspected error in analysis.

TABLE 1B
Parameters of feed water, product water,
and concentrate streams (continued)

| | | Product Water | Concentrate |
|---|---|---|---|
| Parameter | Feed Water | (76% recycled) | (76% recycled) |
| Ca (as CaCO₃) | 199 | 53 | 632 |
| (ppm) | | | |
| M (as CaCO₃) | 34.6 | 10.8 | 103 |
| (ppm) | | | |
| Na (as CaCO₃) | 283 | 163 | 636 |
| (ppm) | | | |
| K (as CaCO₃) | 21 | 9.8 | 59 |
| (ppm) | | | |
| Fe (ppm) | 0.027 | 0.034 | 0.038 |
| Mn (ppm) | 0.026 | 0.008 | 0.66 |
| Al (ppm) | <0.005 | 0.007 | <0.005 |
| Ba (ppm) | 0.037 | 0.011 | 0.149 |
| Sr (ppm) | 0.495 | 0.132 | 14.6 |
| Cu (ppm) | <0.002 | 0.004 | — |
| Zn (ppm) | 0.031 | 0.047 | 0.08 |
| Bicarbonate | 250.6 | 145 | 609.3 |
| (as CaCO₃) | | | |
| (ppm) | | | |
| F (as CaCO₃) | <0.02 | <0.02 | <0.02 |
| (ppm) | | | |
| Cl (as CaCO₃) | 137 | 46.1 | 446 |
| (ppm) | | | |
| Br (as CaCO₃) | 2.64 | 0.709 | 5.75 |
| (ppm) | | | |
| NO₃ (as CaCO₃) | 4.84 | 1.31 | 14.6 |
| (ppm) | | | |
| PO₄ (as CaCO₃) | 19.1 | 9.6 | 40.6 |
| (ppm) | | | |
| Sulfate (as CaCO₃) | 108 | 39.7 | 329 |
| (ppm) | | | |
| Silica (ppm) | 12.5 | 25.1 | 3.29 |
| pH (sample) | 7.61 | 7.31 | 7.52 |
| pH (in field) | — | — | — |
| Turbidity (NTU) | 0.401 | 0.4 | 0.621 |
| Conductivity | 1032 | 484 | 2648 |
| (uS/cm) | | | |
| Conductivity | 1022 | 485 | 2600 |
| (in field) | | | |
| (uS/cm) | | | |
| Total hardness | 233.55 | 63.85 | 734.9 |
| (ppm) | | | |
| Temperature | — | — | — |
| (° C.) | | | |
| TDS (by | 705 | 169 | 1647 |
| evaporation) | | | |
| (ppm) | | | |
| TOC (ppm) | 0.401 | 9.8 | 12.342 |
| Free chlorine | 0.5 | — | — |
| (ppm) | | | |

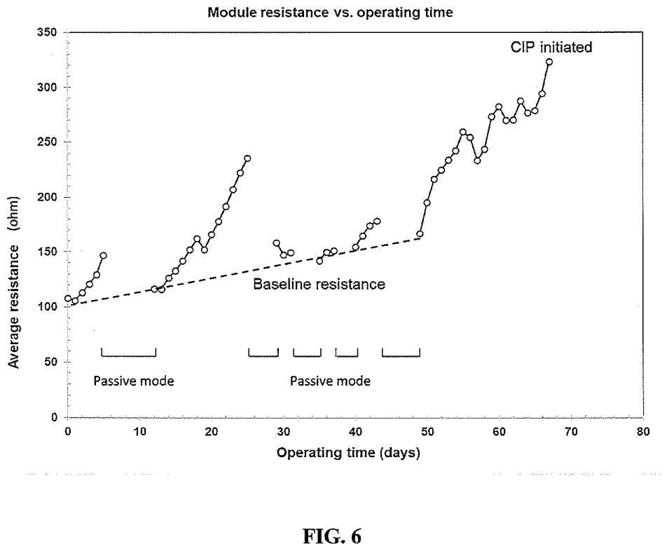

The starting resistance was about 110 ohm. For the first five days of operation the resistance increased to about 150 ohm. During this conventional operation with periodic polarity and flow reversals, the fouling rate on the membranes was too great to continue with normal operation. The electrochemical separation device was regenerated in a passive mode for the next six days. Regeneration in the passive mode resulted in significant reduction in resistance. Following the passive mode regeneration, the resistance almost returned back to the starting resistance. Upon start-up, the resistance was about 110 ohm. The trend continued as shown in the graph of FIG. 6. Almost each regeneration resulted in significant reduction in resistance.

The baseline resistance increased slowly but continuously during cycles over a period of 65 days until the resistance reached about 325 ohm, a level where CIP was performed. After CIP, the resistance was restored to the starting resistance.

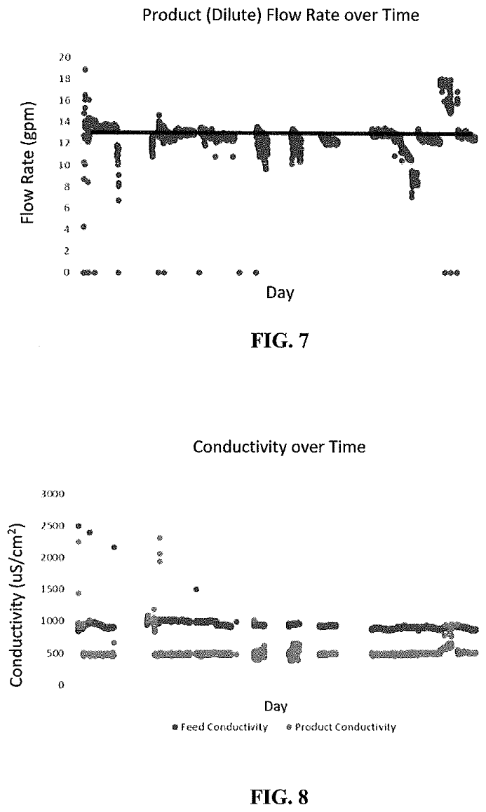

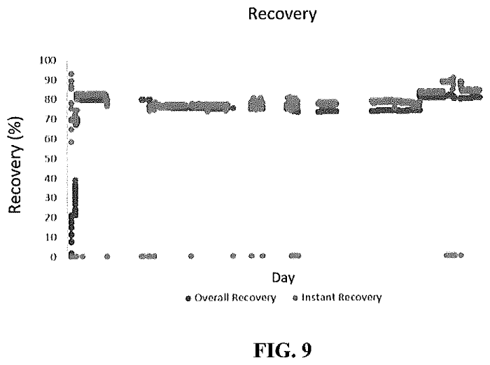

As shown in the graphs of FIGS. 7-9. measurements such as product flow rate and conductivity, water recovery and pressure drop were steady. Briefly, average product flow rate remained steady between about 12-14 gpm (FIG. 7). Product flow rate was between about 8-18 gpm (FIG. 7). Feed stream conductivity remained steady around 1000 uS/cm² (FIG. 8). Product stream conductivity remained steady around 500 uS/cm² (FIG. 8). Overall recovery and instantaneous recovery remained steady at between about 70% and 90%. Fouling was reversible.

Under similar conditions, when applying conventional fouling mitigation methods (for example, periodic polarity and flow reversal) the expected time of operation until CIP is performed is about 10-12 days. In more extreme conditions, CIP may be performed after about 5-6 days of conventional operation. The example shows that operation may be extended to a period that is at least five to ten times longer under the claimed methods as compared to conventional methods.

Thus, electrochemical separation devices may be operated by the methods disclosed herein. Such operation may increase operational time between CIP maintenance and decrease energy consumption. Performance on municipal water treatment is better than during operation with polarity and flow reversal as the only fouling mitigation maintenance. It is expected that regeneration for less than the tested periods of time will have similar results.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A water treatment system comprising:
an electrochemical separation device comprising a dilution compartment having an inlet and a product outlet, a concentration compartment having an inlet and a reject outlet, an ion exchange membrane positioned between the dilution compartment and the concentration compartment, and first and a second electrodes positioned at distal ends of the electrochemical separation device;
a first feed line fluidly connected to the dilution compartment inlet;
a second feed line fluidly connected to the concentration compartment inlet;
a first sensor configured to measure conductivity in the electrochemical separation device; and
a control module operatively connected to the first sensor and the first and second electrodes,
the control module configured to suspend transmission of current between the first and second electrodes and close the dilution compartment inlet and the concentration compartment inlet responsive to a conductivity measurement obtained by the first sensor reaching a threshold value,
the control module further configured to resume transmission of the current and open the dilution compartment inlet and the concentration compartment inlet after a predetermined period of time.

2. The system of claim 1, comprising two or more electrochemical separation devices, each electrochemical separation device individually connected to the first feed line and the second feed line.

3. The system of claim 2, wherein the control module is configured to suspend transmission of the current and close the dilution compartment inlet and the concentration compartment inlet of the two or more electrochemical separation devices nonsimultaneously.

4. The system of claim 1, further comprising a second sensor configured to measure flow rate of at least one of fluid in the first feed line and fluid in the second feed line, the second sensor operatively connected to the control module.

5. The system of claim 1, further comprising a third sensor configured to measure composition of at least one of fluid in the first feed line and fluid in the second feed line, the third sensor operatively connected to the control module.

6. The system of claim 1, further comprising a fourth sensor configured to measure pressure drop in at least one of the concentration compartment and the dilution compartment, the fourth sensor operatively connected to the control module.

7. A method of facilitating operation of an electrochemical separation device comprising a dilution compartment having an inlet fluidly connectable to a first feed line and a product outlet, a concentration compartment having an inlet fluidly connectable to a second feed line and a reject outlet, an ion exchange membrane positioned between the dilution compartment and the concentration compartment, first and a second electrodes positioned at distal ends of the electrochemical separation device, a sensor configured to measure conductivity in the electrochemical separation device, and a control module operatively connected to the first sensor and to the first and second electrodes, the method comprising:
providing a control sequence configured to instruct the control module to operate the electrochemical separation device in an active mode responsive to a conductivity measurement obtained by the first sensor reaching a threshold value or after a first predetermined period of time, and regenerate the electrochemical separation device in a passive mode after a second predetermined period of time.

8. The method of claim 7, further comprising providing the sensor.

9. The method of claim 7, further comprising providing the control module.

10. The method of claim 7, further comprising instructing a user to select at least one of the threshold resistance, the first predetermined period of time, and the second predetermined period of time.
